(19) United States
(12) Patent Application Publication
(10) Pub. No.: US 2026/0134524 A1
(43) Pub. Date: May 14, 2026

(54) COMPLEXITY BASED INPAINTER SELECTION TECHNIQUES

(71) Applicant: Adobe Inc., San Jose, CA (US)

(72) Inventors: Connelly Stuart Barnes, Seattle, WA (US); Xiaoyang Liu, Bellevue, WA (US); Sohrab Amirghodsi, Seattle, WA (US)

(73) Assignee: Adobe Inc., San Jose, CA (US)

(21) Appl. No.: 18/942,015

(22) Filed: Nov. 8, 2024

(51) Int. Cl. G06T 5/77; G06T 5/60; G06V 10/26; G06V 10/82; G06V 20/70

(52) U.S. Cl. CPC G06T 5/77; G06T 5/60; G06V 10/26; G06V 20/70; G06T 2207/20081; G06T 2207/20084; G06V 10/82

(57) ABSTRACT

Complexity based inpainter selection techniques are described. In one or more examples, a semantic segmentation map is generated having labels for pixels of a digital image. An amount of complexity is detected based on the labels for the pixels. Fill for the region is then generated using at least one inpainter module selected from a plurality of inpainter modules based on the amount of complexity. The digital image is presented as having the fill for display in a user interface.

### BACKGROUND

Inpainting refers to operations as implemented by an inpainter module of a computing device to generate “fill” for regions within a digital image. Inpainting, for instance, is usable in support of object removal, hole filling, visual artifact correction (e.g., to remove “distractors”), and so forth for the digital image. To do so, the inpainter module generates color values for pixels within a corresponding region of the digital image, i.e., the hole to be filled, the distractor or other object to be removed, and so forth.

In practice, however, there are a variety of different types of inpainter modules having different strengths and weaknesses in generating the fill, e.g., consume different amounts of computational resources, take different amounts of time to execute by the computing device, support of different usage scenarios, and so on. As a result, conventional techniques involve specialized knowledge often gained over a significant amount of time in order for a user to manually select an inpainter module to generate fill that is visually pleasing. As such, conventional techniques are typically ill suited for use by casual users and involve significant amounts of computational resources consumption as part of a trial and error process.

### SUMMARY

Complexity based inpainter selection techniques are described. These techniques are usable by an inpainting system to estimate an amount of complexity associated with a region, for which, fill is to be generated. The inpainting system is then configured to select an inpainter module from a plurality of inpainter modules based on the estimated amount of complexity.

In one or more examples, a semantic segmentation map is generated having labels for pixels of a digital image. A boundary is then computed of a region within the digital image. An amount of complexity of the boundary is detected based on the labels for the pixels in the boundary. Fill for the region is generated using at least one inpainter module selected from a plurality of inpainter modules based on the amount of complexity. The digital image is presented as having the fill for display in a user interface.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ complexity based inpainter selection techniques described herein.

FIG. 2 depicts a system in an example implementation showing operation of an inpainting system of FIG. 1 in greater detail as implementing complexity based inpainter selection.

FIG. 3 depicts a system in an example implementation showing operation of a region detection module and a region metadata detection module of FIG. 2 in greater detail.

FIG. 4 depicts an example implementation showing computation of an intersection in greater detail.

FIG. 5 depicts a system in an example implementation of list formation of inpainter modules for use in generating fill based on a detected amount of complexity associated with a region.

FIG. 6 is a flow diagram depicting an algorithm as a step-by-step procedure in an example implementation of operations performable for accomplishing a result of complexity based inpainter selection.

FIG. 7 depicts an example implementation of a per cluster allowed inpainter workflow that is usable to analyze regions on a per cluster basis.

FIG. 8 depicts an example implementation of a pseudocode description involving evaluation of panoptic and region masks for each region to select an inpainter module.

FIG. 9 depicts an example implementation of a pseudocode description that is configured to determine whether a region is considered part of complex objects included in a digital image.

FIG. 10 illustrates an example system including various components of an example device that can be implemented as any type of computing device as described and/or utilize with reference to FIGS. 1-9 to implement embodiments of the techniques described herein.

### DETAILED DESCRIPTION

### Overview

A variety of inpainter modules are executable by a computing device in support of a variety of functionality, examples of which include object removal, hole filling, visual artifact correction (e.g., to remove “distractors”), and so forth. Conventional techniques used to select from this variety, however, are performed manually a user and as a result involve specialized knowledge that is typically gained over a significant amount of time. As a result, conventional techniques generally involve an excessive use of computational resources as part of a trial-and-error process to achieve a desired result.

Accordingly, to address these and other technical challenges complexity based inpainter selection techniques are described. These techniques are usable by an inpainting system to estimate an amount of complexity associated with a region, for which, fill is to be generated. The inpainting system is then configured to select an inpainter module from a plurality of inpainter modules based on the estimated amount of complexity.

The inpainter system, for instance, is configurable to select a first inpainter module executed locally on a computing device for a region having less than a threshold amount of complexity and employ a second inpainter module executed remotely (e.g., as part of a digital service) for a region having greater than the threshold amount of complexity. The first inpainter module, for example, supports execution with reduced resource consumption locally but does not support complex scenarios involving object completion, perspective patterns, and so forth. The second inpainter module, however, does support complex scenarios but consumes greater amounts of computational resources which likewise involve a greater amount of time to execute. The inpainter system, therefore, is configurable to select an inpainter module based on an amount of complexity exhibited for generating fill in particular scenarios. In this way, the inpainting system is configurable to improve fill generation results and also optimize computational resource consumption, which is not possible in conventional techniques.

To do so, in one or more examples, the inpainting system begins by forming a semantic segmentation map from the digital image, in which labels are specified for respective pixels from the digital image. The labels, for instance, may be classified into simple object labels that pertain to a simple object class. The inpainting system then forms one or more complex object masks by inverting a simple object mask formed based on the simple object labels from the semantic segmentation map.

The inpainting system also forms a region mask defining a region within the digital image that is to receive the fill. A boundary is then created by the inpainting system by dilating the region mask (e.g., to expand the region mask outward) and then subtract the region mask from the dilated region mask, leaving the boundary defined using a respective boundary mask. The boundary is then usable as a basis to estimate an amount of complexity likely involved in generating fill for the region by a respective inpainter module.

Intersection of boundary with complex object masks, for instance, is usable to determine whether the region mask intersects other complex objects in the digital image. This intersection provides insight that the boundary has a relatively high amount of complexity that likely involves a corresponding high amount of complexity in generating fill, object completion, and so forth for the associated region. On the other hand, lack of such intersection likely involves a lesser amount of complexity (i.e., less than a threshold value) in generating the fill.

Based on these insights, the inpainting system is configurable to select a corresponding inpainter module based on the complexity. The inpainting system, for instance, is configurable to select a local inpainter module for simple fills and a remote inpainter module that implements generative artificial intelligence using machine learning (e.g., a diffusion model) to generate complex fill.

In additional examples, fills are processed an analyzed by successive use of inpainter modules to arrive at a desired result. For example, a first inpainter module that is “weak” result wise but consumes limited amounts of processing resources is selected first, e.g., CMGAN based on complexity. A resulting fill is then analyzed (e.g., for visual artifacts) which, if not meeting a threshold amount of accuracy, causes selection of a second inpainter module, e.g., a diffusion model.

In this way, the inpainting system improves accuracy in achieving a desired result as well as optimizes computational resource consumption, which is not possible in conventional techniques. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “diffusion model” is a type of generative machine-learning model that is used for digital content creation, e.g., digital images. In order to train a diffusion model, noise is added to training data samples until the data within the training data samples is obscured. The diffusion model is then trained to reverse this process based on training data that also has a text prompt that describes the digital content to be created in order to generate data samples as the digital content that corresponds to the text prompt. Diffusion models can also be distilled to decrease the number of parameters or the number of inference steps, which can in some cases enable these models to run locally on user devices.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Inpainter Environment

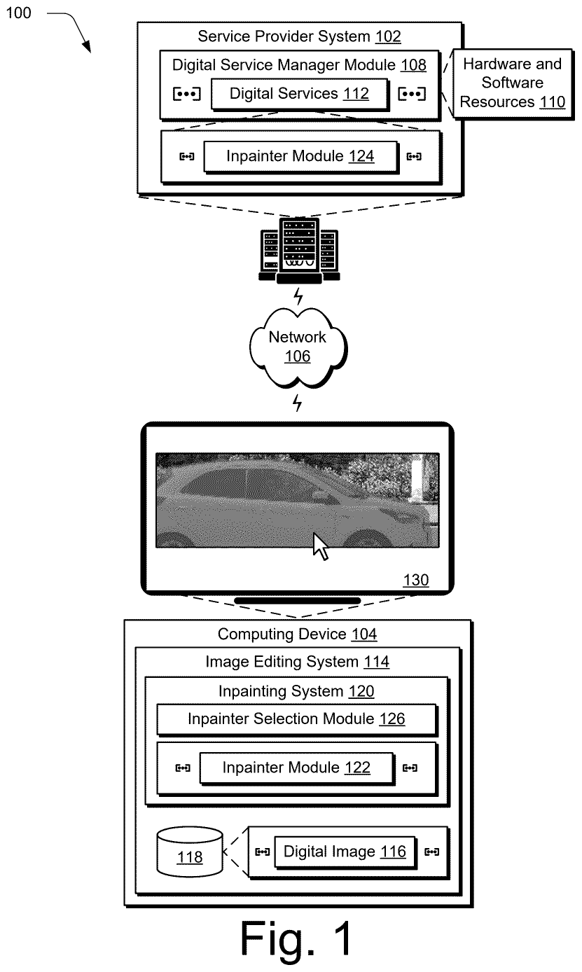

FIG. 1 is an illustration of an environment 100 in an example implementation that is operable to employ complexity based inpainter selection techniques described herein. The illustrated environment 100 includes a service provider system 102 and a computing device 104 that are communicatively coupled, one to another, via a network 106. Computing devices are configurable in a variety of ways.

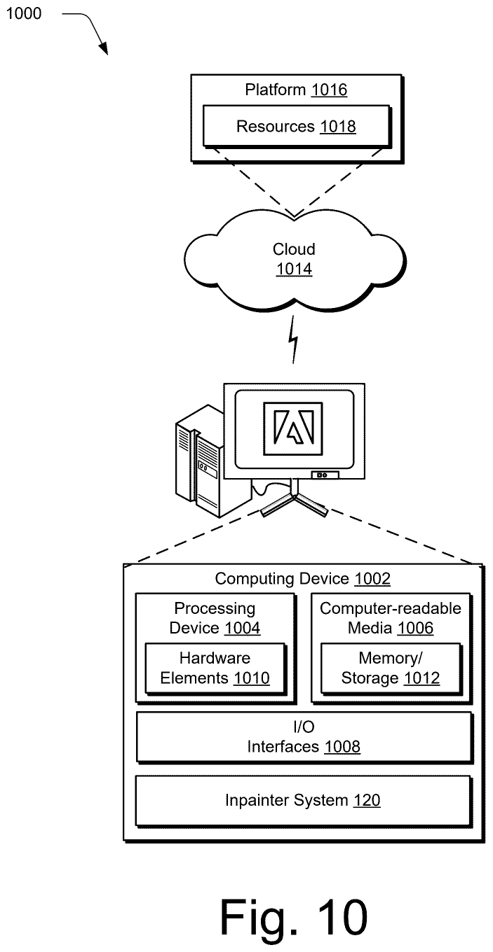

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 10.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, an image editing system 114 is utilized by the computing device 104 to access the one or more digital services 112 via the network 106. A result of processing using the digital services 112 is then returned to the computing device 104 via the network 106.

The computing device 104 is illustrated as including a plurality of digital images, an example of which is illustrated as digital image 116 as stored in a storage device 118. The image editing system 114 is then configured to execute one or more operations to edit the digital image 116, including creating the digital image 116, making a change to the digital image 116, and so forth.

Inpainting refers to techniques usable to generate color values for pixels within a region of a digital image. Inpainting, for instance, may be performed using one or more algorithms, rule-based techniques, employ machine learning, generative artificial intelligence, and so on. Functionality usable to implement inpainting is represented by a plurality of inpainter modules (illustrated as inpainter module 122) that are executed locally at the computing device 104 and a plurality of inpainter modules (illustrated as inpainter module 124) that are implemented remotely by the service provider system 102 as part of the digital services 112.

The inpainter modules 122, 124 are executable to implement a variety of inpainting techniques. In a first example, the inpainter module 122 is configurable to implement an inpainting technique locally at the computing device 104 that leverages a combination of guided patch-match and auto-curation, e.g., a curator-aided inpainting framework (CAF). Guided patch-match involves use of one or more algorithms to find similar patches within the digital image 116 which are blended to generate the fill. Auto-curation is used to select the “best” patches from candidates (e.g., using a neural network) in a manner to promote a result that is visually coherent and seamless. This technique is particularly effective for textures and repetitive patterns.

In a second example, the inpainter module 124 is configurable to implement an inpainting technique remotely using the digital services 112 of the service provider system 102. The inpainter module 124, for instance, is implemented using one or more machine-learning models to institute generative artificial intelligence (AI). An example of one such technique is referred to as a cascaded modulation GAN (CMGAN). The inpainter module 124 is configurable in this example to implement an encoder with Fourier convolution blocks to extract multi-scale feature presentations from the digital image 116. A dual-stream decoder is then utilized to employ cascaded global-spatial modulation at each scale level to combine a global context with local details. Machine-learning models that are used to implement this technique may incorporate an object-aware training scheme.

A variety of other example are also contemplated. In one such example, the inpainter modules 122, 124 may implement a deep learning-based inpainting technique that leverages neural networks to predict and fill in missing regions of digital image 116. Techniques to do so include use of generative adversarial networks (GANs) and convolutional neural networks (CNNs) that learn from large training datasets to generate realistic and contextually appropriate content for the missing regions, or diffusion models or distilled diffusion models that have a sufficiently small number of parameters to fit in a memory on a user's device, e.g., computing device 104.

In another example, exemplar-based inpainting is employed by the inpainter modules 122, 124 that operate similar to patch-based techniques above. Exemplar-based inpainting uses a priority mechanism to determine an order in which the regions are filled, e.g., by prioritizing regions that are surrounded by known pixels to ensure a coherent and visually pleasing result.

In a further example, sparse representation-based inpainting techniques are employed by the inpainter modules 122, 124. This approach represents the digital image 116 as a sparse combination of base functions. Missing regions are reconstructed by finding a best sparse representation that matches known parts of the digital image 116. This technique is also effective for digital images having complex structures and textures.

In a further example, latent code-based inpainting techniques are employed by the inpainter modules 122, 124. This technique uses latent codes to represent the missing regions of the digital image 116. By learning a latent space that captures the distribution of complete images, the inpainter modules 122, 124 are configurable using one or more machine-learning models to generate multiple plausible fills for the missing regions. This approach is useful for generating diverse and realistic inpainting results.

As previously described, conventional techniques used to select from this variety are performed manually by a user and as a result involve specialized knowledge that is typically gained over a significant amount of time. Consequently, conventional techniques generally involve an excessive use of computational resources as part of a trial-and-error process to achieve a desired result, e.g., a visually pleasing fill of a region within a digital image.

Accordingly, to address these and other technical challenges the inpainting system 120 employes an inpainter selection module 126 to select from the plurality of inpainter modules 122, 124, automatically and without user intervention. To do so, the inpainter selection module 126 in one or more examples is configured to estimate an amount of complexity associated with a region, for which, fill is to be generated and select an inpainter module from the plurality of inpainter modules 122, 124 based on this complexity.

The inpainter selection module 126, for instance, is configurable to select a local inpainter module 122 for a simple fill and a remote inpainter module 124 that implements generative artificial intelligence using machine learning (e.g., a diffusion model) to generate a complex fill. In this way, the inpainting system 120, through use of the inpainter selection module 126, improves accuracy in achieving a desired result as well as optimizes computational resource consumption, which is not possible in conventional techniques. Further discussion of these and other examples is included in the following section and shown in corresponding figures.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Complexity Based Inpainter Selection

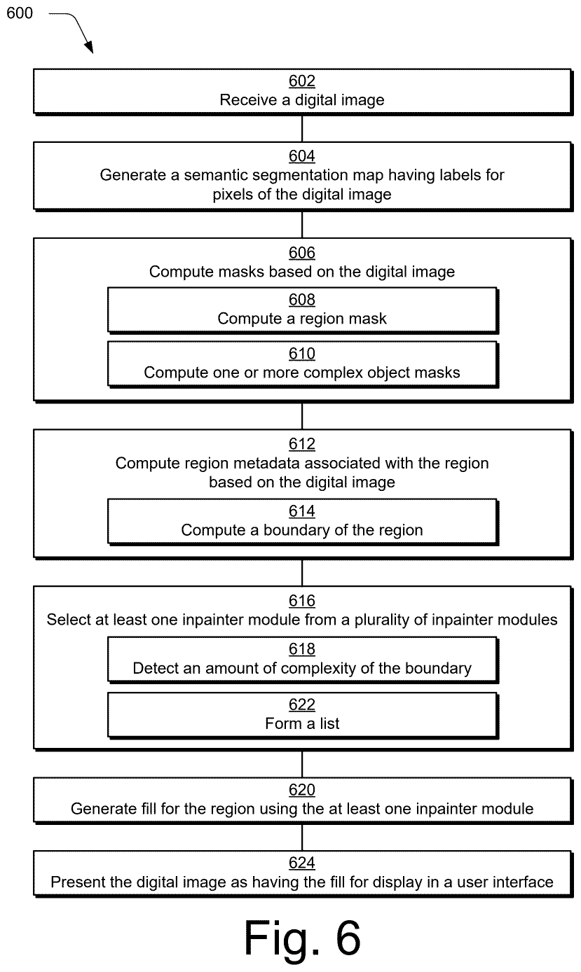

The following discussion describes inpainter selection techniques that are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 6 is a flow diagram depicting an algorithm 600 as a step-by-step procedure in an example implementation of operations performable for accomplishing a result of complexity based inpainter selection. In portions of the following discussion, reference will be made to corresponding systems in parallel with FIG. 6.

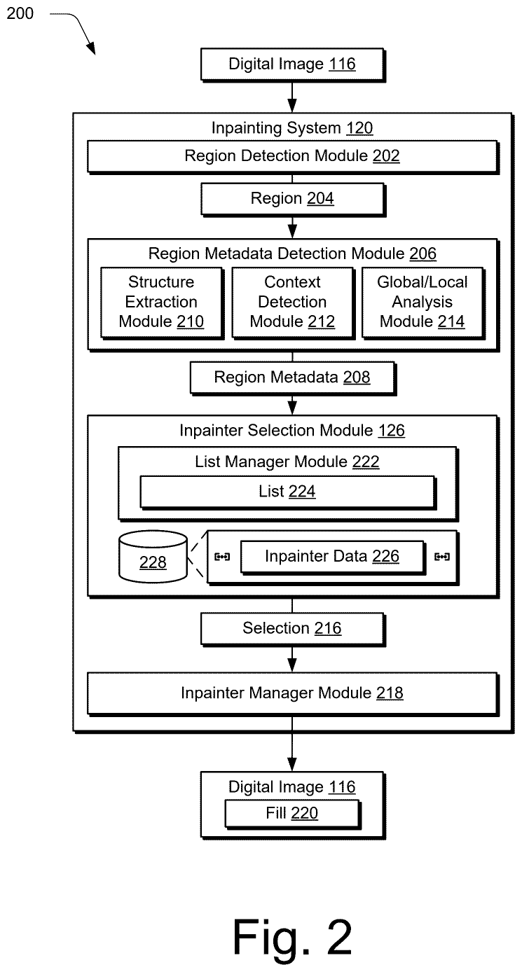

FIG. 2 depicts a system 200 in an example implementation showing operation of the inpainting system 120 of FIG. 1 in greater detail as implementing complexity based inpainter selection. To begin in this example, a digital image 116 is received (block 602) by the inpainting system 120. The digital image 116, for instance, is configurable as a JPEG, PNG, bitmap, vector image, captured through use of a digital camera, from a stock digital image source, downloaded from a social media service, and so forth.

In response, the inpainting system 120 employs a region detection module 202 to detect a region 204 that is to be used as a basis for generating fill. A region metadata detection module 206 is also employed to detect region metadata 208 that describes characteristics of the region 204 and surrounding area.

A user input, for instance, may be received via a user interface 130 as shown in FIG. 1 to specify the region, e.g., by “clicking” on an object to be removed using a cursor control device as illustrated. Other automated examples are also contemplated, e.g., distractor removal to remove visual artifacts such as water droplets, dust, and so forth. The region detection module 202 then identifies the region as corresponding to the input, as having the distractor, and so forth. To do so, the region detection module 202 is configurable to use object recognition as implemented using a machine-learning model, leverage pixel similarity from a selection point to determine a boundary of the region, and so forth.

The region metadata detection module 206 is configured to generate region metadata 208 that provides insights related the region 204 and portions of the digital image 116 that surround the region 204. Illustrated examples of which include a structure extraction module 210 that is configured to employ a structure extraction from texture via relative total variation (RTV) analysis at a sub-resolution area to determine an amount of structure associated with the region 204. A context detection module 212 is representative of functionality to provide context of the digital image 116 that surrounds the region 204. The global/local analysis module 214 is configured to add a concept of global and local per-region inpainter modules as an additional layer of per-region analysis as a basis to further refine the selection process by the inpainter selection module 126 as further described below.

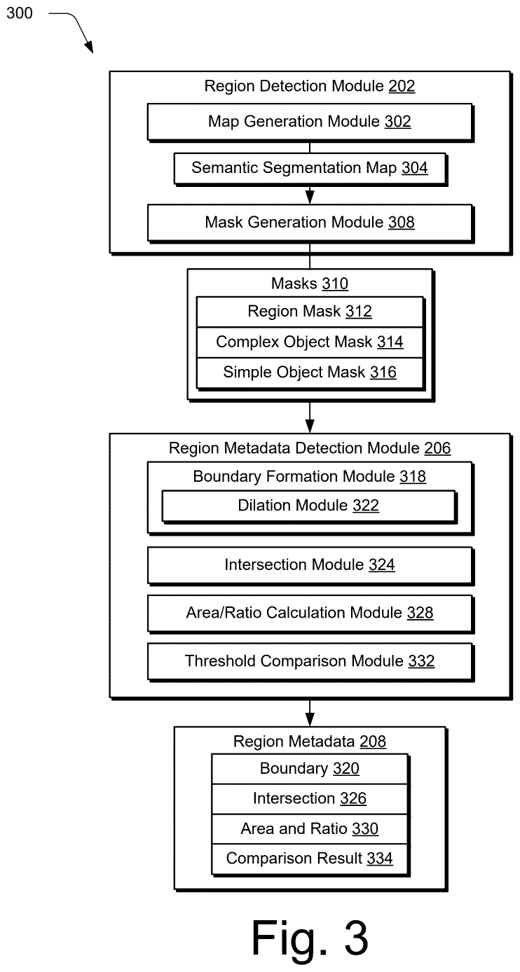

FIG. 3 depicts a system 300 in an example implementation showing operation of the region detection module 202 and the region metadata detection module 206 of FIG. 2 in greater detail. The region detection module 202 begins in the illustrated example as employing a map generation module 302 to generate a semantic segmentation map 304 having labels for pixels of the digital image 116 (block 604).

The map generation module 302, for instance is configured to utilize one or more machine-learning models (e.g., convolutional neural networks) as part of a computer vision technique to assign a class label to pixels in the digital image. The machine-learning models are trained on training datasets having digital images and labeled pixels. The machine-learning models, once trained, extract features from the digital image 116 at multiple scales and combines these features to make pixel-level predictions using convolution, pooling, and upsampling. Boundaries of respective masks may then be refined, e.g., using conditional random fields (CRFs). The semantic segmentation map 304 that is output therefore indicates a class of each pixel in the digital image 116, which may be output as an overlay over the digital image 116.

The semantic segmentation map 304 is then input to a mask generation module 308. Masks 310 are computed by the mask generation module 308 based on the digital image 116 (block 606), e.g., based on the labels of the pixels from the semantic segmentation map 304. Examples of masks 310 computed based on the digital image include a region mask 312 (block 608) to define a region to be filled in the digital image 116 and one or more complex object masks 314 (block 610). The one or more complex object masks 314 may be computed based on the labels from the semantic segmentation map 304 directly (e.g., for objects having identified complex structures) and/or indirectly through computation of a simple object mask 316 which is then inverted to form the one or more complex object masks 314.

The mask generation module 308, for instance, may compute the simple object masks 316 based on class labels associated with simple objects, e.g., having relative uncomplicated structures such as mountains, natural ground, plants, sky, water, and so forth. The mask generation module 308 then inverts the simple object masks 316 to form the complex object mask 314 as having complex structures, e.g., foreshortening of lines in manmade tile flooring, complex building textures, and so forth. A variety of other examples are also contemplated. The masks 310 are then passed as an input to the region metadata detection module 206 in the illustrated example of FIG. 3.

Region metadata 208 is then computed by the region metadata detection module 206 that is associated with the region based on the digital image 116 (block 612). As described above, region metadata 208 is usable to describe characteristics associated with the region itself and/or characteristics of an area of the digital image 116 that is disposed adjacent to the region. In this way, the region metadata is usable to provide additional insight into “what” is to be generated as fill for the region. Accordingly, the region metadata 208 is configurable in a variety of ways.

In a first example, a boundary formation module 318 is configured to compute a boundary 320 (block 614) as part of the region metadata 208. The boundary formation module 318, for instance, employs a dilation module 322 to dilate the region mask 312 to form a dilated region mask. To do so, the boundary formation module 318 expands an outer boundary of the region mask 312 by a threshold amount, e.g., a number of pixels. The boundary formation module 318 then subtracts the region mask 312 from the dilated boundary mask to form the boundary 320 as a boundary mask, e.g., as a ribbon which at least partially surrounds the region mask 312. The boundary 320 is then usable in support of generation of a variety of mask generation module 308 that is usable as an insight into complexity associated with the region and therefore which inpainter module to select based on that insight.

In a second example, for instance, an intersection module 324 is configured to compute an intersection 326 of the boundary 320 (e.g., the boundary mask) with the complex object mask 314. The intersection 326 thus defines an outline where the area of the boundary 320 that intersects the simple object masks 316 is removed and the area that intersects a complex object mask 314 remains.

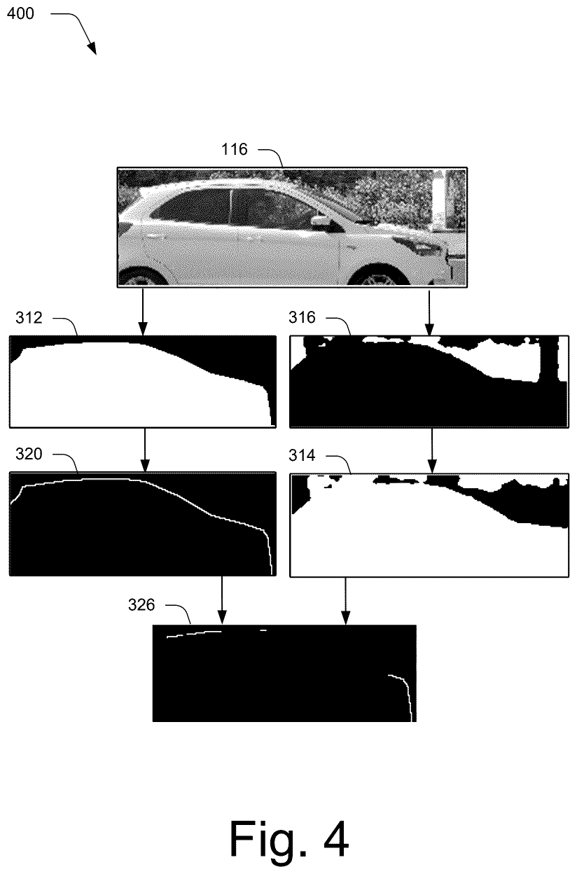

FIG. 4 depicts an example implementation 400 showing computation of the intersection 326 in greater detail. As illustrated, a region mask 312 and a simple object mask 316 are generated from a digital image 116. The region mask 312 is dilated to form a dilated region mask, e.g., expanded by a threshold amount. The region mask 312 is then subtracted from the dilated region mask to form a boundary 320. The simple object mask 316 is inverted to form the complex object mask 314. An intersection 326 of the boundary 320 and the complex object mask 314 is then output, which is usable to provide insight into a likely an amount of complexity involved in generating fill for the region as further described below.

Returning again to FIG. 3, in a third example an area/ratio calculation module 328 is configured to calculate an area and ratio based on the intersection 326. The area/ratio calculation module 328, for instance, first measures a total area of the boundary 320 (e.g., in pixels) and an area of the intersection 326, e.g., in pixels. A ratio of the intersection 326 area to the boundary 320 area is computed. Thus, the area/ratio calculation module 328 is configurable to calculate the area and ratio 330 as insight into an amount of complexity.

A threshold comparison module 332 is then employed to leverage a threshold to determine whether a relative amount of complexity associated with the boundary 320 based on the ratio of the intersection 326 is above or below the threshold, i.e., is or is not considered “complex.” Thus, a comparison result 334 output by the threshold comparison module 332 is usable to guide selection of an inpainter module based on an amount of complexity exhibited by the ratio as further described below.

Returning again to FIG. 2, the region 204 and the region metadata 208 are then provided as an input to the inpainter selection module 126 to select at least one inpainter module from the plurality of inpainter modules 124 (block 616), e.g., to “make the selection 216.” In a first example, the selection 216 is performed responsive to detecting an amount of complexity of the boundary based on the labels for the pixels in the boundary (block 618). Continuing with the previous example, the inpainter selection module 126 receives the comparison result 334 of the boundary 320 and the intersection 326 which is usable to quantify a relative amount of complexity exhibited by the boundary 320, and therefore likely involved in generating fill for the region.

Intersection of boundary with the complex object masks, for instance, is usable to provide insight as to whether the region mask intersects other complex objects in the digital image. This intersection 326 provides insight as to whether the boundary has a relatively high amount of complexity that likely involves a corresponding high amount of complexity in generating fill, object completion, and so forth for the associated region. On the other hand, a relatively low amount of such intersection 326 indicates a relatively lesser amount of complexity (i.e., less than a threshold value) in generating the fill.

Based on these insights, the inpainter selection module 126 is configurable to select a corresponding inpainter module 122, 124 based on the complexity. The inpainter selection module 126, for instance, is configurable to select a local inpainter module 122 for simple fills and a remote inpainter module 124 that implements generative artificial intelligence using machine learning (e.g., a diffusion model) to generate complex fill. An inpainter manager module 218 is then employed to initiate operation of a selected inpainter module to generate fill 220 for the region (block 620), which is then presented for display in a user interface 130 (block 624).

In a second example, the selection is performed by forming a list (block 622). A list manager module 222, for instance, is configurable to generate a list 224 of which inpainter modules 122, 124 are to be considered for generating the fill 220. This list 224 is generated based on inpainter data 226 (stored in a storage device 228) describing functionality associated with the respective inpainter modules, e.g., a relative amount of processing resources consumed, resource consumption, time of completion, an amount of complexity supported, fill generation strengths and weaknesses, and so on.

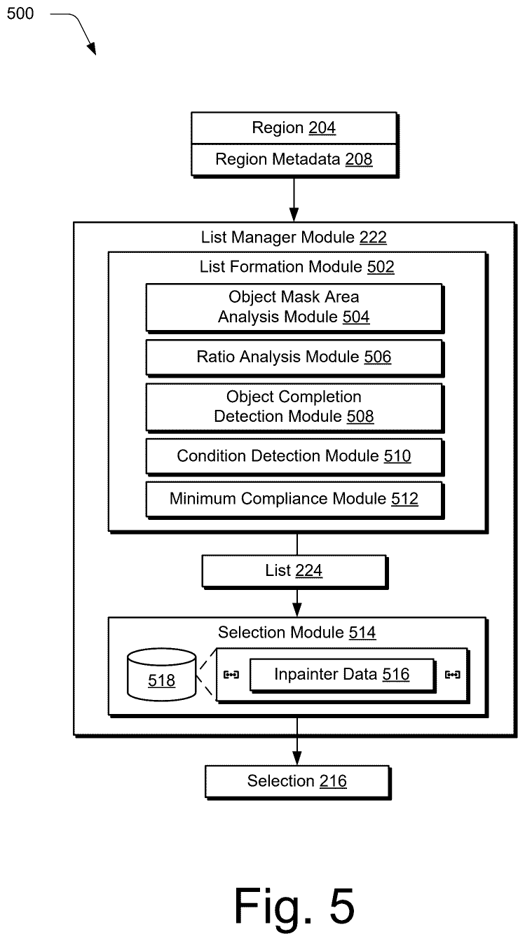

FIG. 5 depicts a system 500 in an example implementation of list formation of inpainter modules for use in generating fill based on a detected amount of complexity associated with a region. The list 224, for instance, is configurable to include weights assigned to respective inpainter modules based on the amount of complexity which are then usable to select one or more of the inpainter modules for actual use.

To do so, the list manager module 222 includes a list formation module 502 that is configured to control which of the inpainter modules 122, 124 are available for use in fill generation. The list formation module 502 is configurable to analyze the region 204 and the region metadata 208 (e.g., which includes the boundary 320) to gain insight into an amount of complexity that is likely involved in generating the fill.

The list formation module 502, for instance, includes an object mask area analysis module 504 that is configured to analyze the intersection 326 as in indicator of a likely amount of complexity as described above. Likewise, a ratio analysis module 506 to configurable to analyze the ratio generated by the area/ratio calculation model 328 of the region metadata detection module 206. An object completion detection module 508 is configured to determine whether the fill is likely to involve object completion, e.g., based on the intersection 326, the ratio 330, and so forth. A condition detection module 510 is configured to detect whether certain inpainter modules are included in the list 224, e.g., that are image size independent. A minimum compliance module 512 is also included to ensure that at least one inpainter module of a particular type is included in the list, e.g., CAF.

The inpainter selection module 126, for instance, in an instance in which comparison result 334 indicates that the fill does not likely involve object completion, a higher threshold is set for including CAF and CMGAN is considered in each instance. If the fill does involve object completion, lower thresholds (e.g., 0.35% for CAF and 0.7% for CMGAN) are set as a basis to decide whether to include or exclude respective inpainter modules from the list 224. If conditions for including CAF are met, for instance, CAF is added to the list 224.

Similarly, if conditions for including CMGAN are met and is allowed, this inpainter module is added to the list 224. In an implementation, a check is made as to whether a particular inpainter module is present in the list 224 that is compatible with any image dimensions, and if not is added, e.g., CAF. A variety of other examples are also contemplated.

The list 224 is then output to a selection module 514 that is configured to make the selection 216. The selection module 514, for instance, analyzes inpainter data 516 stored in a storage device 518 that describes processing sources used, an amount of time consumed in fill generation, types of fills supported, and so forth. The selection module 514 then makes the selection 216, which is then used to generate the fill for the region.

In this way, the inpainting system 120 is usable to methodically determine a degree of overlap between the boundary 320 and the one or more complex object masks 314 as the intersection 326 and from this, estimate an amount of complexity associated with generating fill for a region. The inpainting system 120, therefore, is configurable to intelligently decide whether a region interests with complex subject matter, thereby influencing a choice of inpainting technique to be applied, which is not possible in conventional techniques.

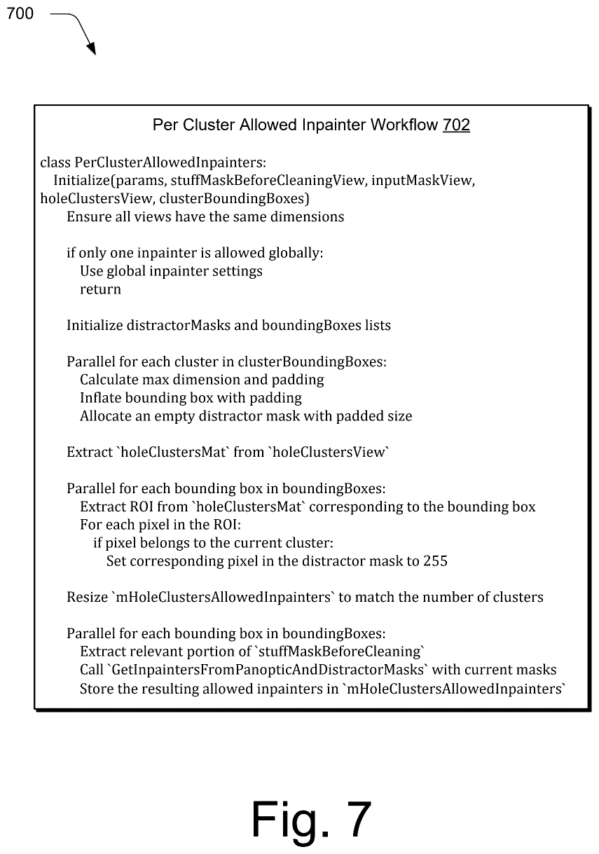

In the following discussion, techniques are described that support addition to inpainter modules to a list as implementing local analysis as a filtering mechanism. FIG. 7 depicts an example implementation 700 of a per cluster allowed inpainter workflow 702 that is usable to analyze regions on a per cluster basis. This class determines for each hole cluster which inpainters are allowed for that cluster by in parallel analyzing the region within each cluster's bounding box.

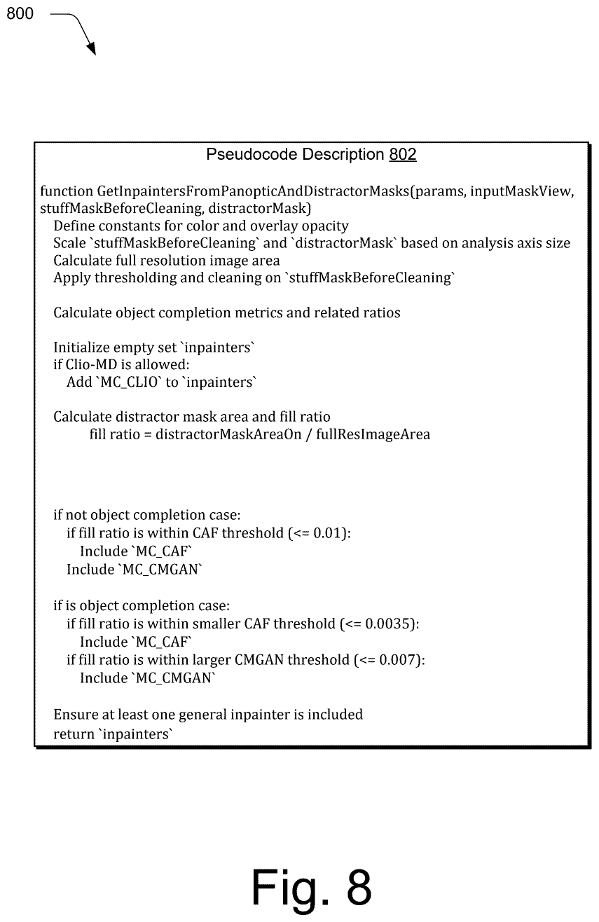

FIG. 8 depicts an example implementation 800 of a pseudocode description 902 involving evaluation of panoptic and region masks for each region to select an inpainter module. In this example, a threshold for “CAF inclusion (Not Object Completion)” is set at less than or equal to 0.01. For “CAF inclusion (Object Completion)” the fill ratio is set at less than or equal to 0.0035. For “CMGAN Inclusion” the fill ratio is set as less than or equal to 0.0007. The function “GetInpaintersFromPanopticAndDistractorMasks” is called for each cluster to determine the set of allowed local inpainter modules.

The local inpainter modules are determined based on the analysis of the region's mask and are further restricted from the global inpainter list. The fill ratio, “ratioOfFillToFullResRegion” is computed as an area of the region mask (count of non-zero pixels) divided by the full resolution area of the digital image, which is derived from the original image dimensions and a scaling factor. This ratio helps determine suitability of certain inpainter modules based on the size of the distracting region relative to the entire image. For example, smaller fill ratios indicate less intrusive distractions, potentially allowing simpler methods like CAF, while larger ratios may involve more advanced methods like CMGAN.

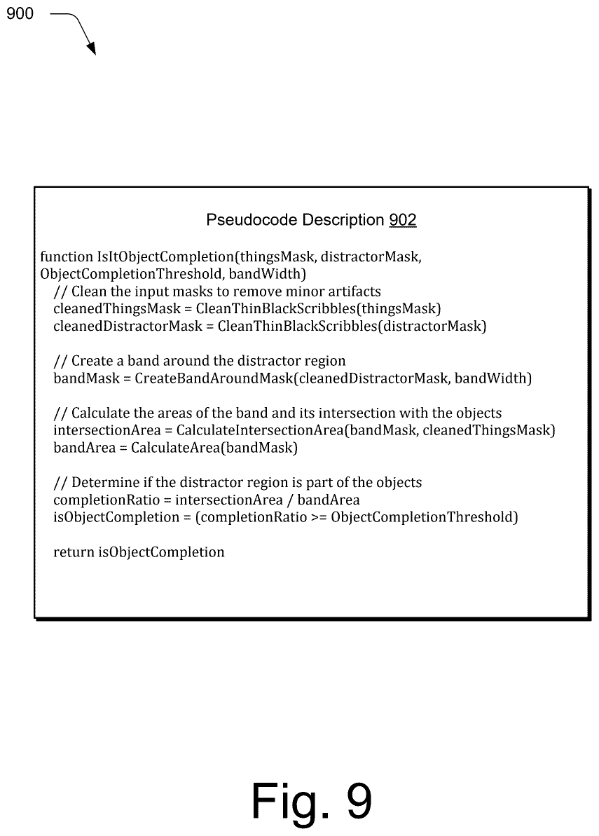

FIG. 9 depicts an example implementation 900 of a pseudocode description 902 that is configured to determine whether a region is considered part of complex objects included in the digital image 116. To do so, a ratio of the intersection area to a total area of a boundary is compared against a predefined threshold. If the ratio exceeds the threshold, the region is considered to significantly overlap complex objects, indicating that the fill involves “object completion.” A variety of other examples are also contemplated.

### Example System and Device

FIG. 10 illustrates an example system generally at 1000 that includes an example computing device 1002 that is representative of one or more computing systems and/or devices that implement the various techniques described herein. This is illustrated through inclusion of the inpainting system 120. The computing device 1002 is configurable, for example, as a server of a service provider, a device associated with a client (e.g., a client device), an on-chip system, and/or any other suitable computing device or computing system.

The example computing device 1002 as illustrated includes a processing device 1004, one or more computer-readable media 1006, and one or more I/O interface 1008 that are communicatively coupled, one to another. Although not shown, the computing device 1002 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1004 is representative of functionality to perform one or more operations using hardware. Accordingly, the processing device 1004 is illustrated as including hardware element 1010 that is configurable as processors, functional blocks, and so forth. This includes implementation in hardware as an application specific integrated circuit or other logic device formed using one or more semiconductors. The hardware elements 1010 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1006 is illustrated as including memory/storage 1012 that stores instructions that are executable to cause the processing device 1004 to perform operations. The computer-readable storage medium is configured for storing instructions that, responsive to execution by the processing device, causes the processing device to perform operations. The memory/storage 1012 represents memory/storage capacity associated with one or more computer-readable media. The memory/storage 1012 includes volatile media (such as random access memory (RAM)) and/or nonvolatile media (such as read only memory (ROM), Flash memory, optical disks, magnetic disks, and so forth). The memory/storage 1012 includes fixed media (e.g., RAM, ROM, a fixed hard drive, and so on) as well as removable media (e.g., Flash memory, a removable hard drive, an optical disc, and so forth). The computer-readable media 1006 is configurable in a variety of other ways as further described below.

Input/output interface(s) 1008 are representative of functionality to allow a user to enter commands and information to computing device 1002, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1002 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1002. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1002, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1010 and computer-readable media 1006 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1010. The computing device 1002 is configured to implement particular instructions and/or functions corresponding to the software and/or hardware modules. Accordingly, implementation of a module that is executable by the computing device 1002 as software is achieved at least partially in hardware, e.g., through use of computer-readable storage media and/or hardware elements 1010 of the processing device 1004. The instructions and/or functions are executable/operable by one or more articles of manufacture (for example, one or more computing devices 1002 and/or processing devices 1004) to implement techniques, modules, and examples described herein.

The techniques described herein are supported by various configurations of the computing device 1002 and are not limited to the specific examples of the techniques described herein. This functionality is also implementable all or in part through use of a distributed system, such as over a “cloud” 1014 via a platform 1016 as described below.

The cloud 1014 includes and/or is representative of a platform 1016 for resources 1018. The platform 1016 abstracts underlying functionality of hardware (e.g., servers) and software resources of the cloud 1014. The resources 1018 include applications and/or data that can be utilized while computer processing is executed on servers that are remote from the computing device 1002. Resources 1018 can also include services provided over the Internet and/or through a subscriber network, such as a cellular or Wi-Fi network.

The platform 1016 abstracts resources and functions to connect the computing device 1002 with other computing devices. The platform 1016 also serves to abstract scaling of resources to provide a corresponding level of scale to encountered demand for the resources 1018 that are implemented via the platform 1016. Accordingly, in an interconnected device embodiment, implementation of functionality described herein is distributable throughout the system 1000. For example, the functionality is implementable in part on the computing device 1002 as well as via the platform 1016 that abstracts the functionality of the cloud 1014.

In implementations, the platform 1016 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
generating, by a processing device, a semantic segmentation map having labels for pixels of a digital image;
detecting, by the processing device, an amount of complexity based on the labels for the pixels;
generating, by the processing device, fill for a region using at least one inpainter module selected from a plurality of inpainter modules based on the amount of complexity; and
presenting, by the processing device, the digital image as having the fill for display in a user interface.

2. The method as described in claim 1, further comprising computing, by the processing device, a boundary of the region within the digital image and wherein the detecting the amount of complexity is based on the boundary.

3. The method as described in claim 2, wherein the detecting the amount of complexity includes generating a simple object mask based on simple object labels from the semantic segmentation map and forming a complex object mask by inverting the simple object mask.

4. The method as described in claim 3, wherein the amount of complexity is based on an amount of said pixels in the boundary that intersect the complex object mask.

5. The method as described in claim 4, wherein the amount of complexity is defined as a ratio of the amount of said pixels in the boundary that intersect the complex object mask relative to a total number of said pixels in the boundary.

6. The method as described in claim 1, wherein the at least one inpainter module is a first said inpainter module selected responsive to determining that the amount of complexity is less than a threshold amount and a second said inpainter module, different from the first said inpainter module, is selected responsive to determining that the amount of complexity is greater than the threshold amount.

7. The method as described in claim 1, further comprising forming a list of one or more inpainter modules from the plurality of inpainter modules, the list based on the region and region metadata associated with the region and wherein the at least one inpainter module is selected from the list.

8. The method as described in claim 7, wherein the region metadata described a context detected based on the region and a structure detected based on the region.

9. The method as described in claim 1, wherein the plurality of inpainter modules are configured to perform hole filling or distractor removal.

10. A computing device comprising:
a processing device; and
a computer-readable storage medium storing instructions that, responsive to execution by the processing device, causes the processing device to perform operations including:
generating a semantic segmentation map having labels for pixels of a digital image;
detecting an amount of complexity based on the labels for the pixels;
generating fill for a region using at least one inpainter module selected from a plurality of inpainter modules based on the amount of complexity; and
presenting the digital image as having the fill for display in a user interface.

11. The computing device as described in claim 10, wherein the generating includes selecting the at least one inpainter module from a list of the plurality of inpainter modules.

12. The computing device as described in claim 11, wherein the list is ordered based on a relative amount of processing resources consumed, respectively, by the plurality of inpainter modules.

13. The computing device as described in claim 11, wherein the list is ordered based on an amount of complexity supported, respectively, by the plurality of inpainter modules.

14. The computing device as described in claim 10, wherein the operations further comprise computing a boundary of the region within the digital image and wherein the detecting the amount of complexity is based on the boundary.

15. The computing device as described in claim 14, wherein the detecting the amount of complexity includes generating a simple object mask based on simple object labels from the semantic segmentation map and forming a complex object mask by inverting the simple object mask.

16. One or more computer-readable storage media storing instructions that, responsive to execution by a processing device, causes the processing device to perform operations comprising:
generating a semantic segmentation map having labels for pixels of a digital image;
detecting an amount of complexity based on the labels for the pixels;
generating a first fill for a region using a first inpainter module selected from a plurality of inpainter modules based on the amount of complexity;
selecting a second inpainter module from the plurality of inpainter modules based on the first fill for the region generated by the first inpainter module and
generating a second fill for the region using the second inpainter module.

17. The one or more computer-readable storage media as described in claim 16, wherein the detecting the amount of complexity includes generating a simple object mask based on simple object labels from the semantic segmentation map and forming a complex object mask by inverting the simple object mask.

18. The one or more computer-readable storage media as described in claim 17, wherein the amount of complexity is based on an amount of said pixels in a boundary of the region that intersect the complex object mask.

19. The one or more computer-readable storage media as described in claim 18, wherein the amount of complexity is defined as a ratio of the amount of said pixels in the boundary that intersect the complex object mask relative to a total number of said pixels in the boundary.

20. The one or more computer-readable storage media as described in claim 16, wherein the first inpainter module is selected responsive to determining that the amount of complexity is less than a threshold amount.
